(19) United States
(12) Patent Application Publication
(10) Pub. No.: US 2004/0007309 A1
(43) Pub. Date: Jan. 15, 2004

(54) Tack knife

(76) Inventors: Kevin Owen, Flowery Branch, GA (US); Kenny McCracken, Lawrenceville, GA (US)

Correspondence Address: Gerald Levy, Esq., PITNEY, HARDIN, KIPP & SZUCH LLP, 685 Third Avenue, New York, NY, 10017-4024, US

(21) Appl. No.: 10/193,560

(22) Filed: Jul. 11, 2002

(51) Int. Cl. B32B 31/18; B65D 33/24

(52) U.S. Cl. 156/66; 156/251; 156/258; 156/264; 156/515; 156/518; 156/519

(57) ABSTRACT

An apparatus, device (10) and method for simultaneously producing tack-seals (28, 34) and for cutting a zipper (12) from a continuous length of zipper before the zipper is attached to the thermoplastic film (38) used to make a reclosable bag. A first end section (26) of the zipper (12) is cut and fused by a heated blade (24) of the device (10), thereby providing a first tack-seal (28). The zipper (12) is advanced and a second end section (32) is cut and fused by the heated blade (24) of the device (10), thereby providing a second-tack seal (34) so that the zipper includes a pair of tack-seals at both ends of the zipper.

### BACKGROUND OF THE INVENTION

1. Field of the Invention

The present invention relates to the application of zippers to thermoplastic film used to make reclosable plastic bags. More specifically, the present invention relates to a device for tack-sealing the cut ends of a zipper as the zipper or fastener strip is cut from a continuous length of zipper.

2. Description of the Prior Art

The present invention relates to improvements in the package-making art and may be practiced in the manufacture of reclosable plastic bags and packages of the type that may be used for various consumer products. Such packages often include a form of peel-seal to render the package moisture and/or airtight prior to the initial opening, and/or a tamper-evident seal. A zipper with interlocking profiles protects any remainder of the product therein after the initial opening.

The indicated art is fairly well developed but nevertheless remains open to improvements contributing to increased efficiency and cost-effectiveness in the package-making art. In the prior art, McMahon et al. (U.S. Pat. No. 4,909,017) discloses a method of making a form-fill bag having a reclosable fastener. Prior to entering a form-fill and seal (FFS) machine, fastener strips are attached to the surface of the film transverse to the running direction at bag length intervals. The fastener strips contain pre-joined interlocked rib and groove strips. Only one of the strips is attached to a top surface of the film with the other strip facing upwardly or, in other words, inwardly toward the interior of the bag to be formed. The attached strips are secured at the center of the film and each strip is less than half of the film's width. The film is then advanced to the FFS machine and drawn down over a forming collar and about the filling tube, with the longitudinal side edge margins of the film brought together and seamed with a fin seal to form a tube. Cross-seals are made across the tube to join the unattached fastener strip to form the top and bottom of the bag.

A problem is sometimes encountered during attachment of the fastener or zipper to the film. Typically a roller-type applicator engages one profile of the zipper and positions the zipper on the film used on the FFS machine. The other profile of the zipper is interlocked with the engaged profile by their interlocking members. The other profile moves to be attached to the film as a result of both profiles being interlocked. However, if the profiles are not securely interlocked at their interlocking members, the profiles may significantly misalign in relation to each other as the roller moves the profile on which it is engaged. This misalignment of the zipper profiles makes it difficult to properly seal the zipper to the film, resulting in a defective zipper after formation of the reclosable bag.

In the patent application entitled “Transverse Direction Zipper End Sealer” (U.S. Ser. No. 09/991,400; filed Nov. 21, 2001) a cutting device includes a heating element within a blade, with the heating element separated from the cutting face of the blade by a clearance. As the cutting device separates a fastener strip from a supply of fastener strip, the heating element fuses the interlocking members of the fastener strip thereby providing an end stop. As the fastener strip is cut for a second time to produce a length of fastener strip used for a reclosable bag, the cutting device fuses the other end of the fastener strip to provide a second end stop. With end stops on both ends of the length of fastener strip, a future rupture of the ends of the fastener strip and the side seams of the reclosable bag is prevented.

An improvement in the application of zippers to the film used to make a reclosable bag is the ability to make tack-seals instead of end stops on the fastener strips. Similar to the end stops, the tack-seals also serve to reinforce the profile ends of the zipper, thereby keeping the profiles aligned with each other during attachment to the film used to make a reclosable bag. However, unlike end seals formed as end stops, the tack-seals can easily be separated. After being separated by a consumer during use, the separated tack-seals allow the consumer to align multiple interlocking profiles of a zipper to multiple interlocking positions.

### SUMMARY OF THE INVENTION

Accordingly, the present invention relates to a device for producing tack-seals on end sections of a fastener strip as the fastener strip is being cut from a supply of fastener strip or zipper. The fastener strip or zipper is interlocked by the interlocking members of two opposing profiles. A heated cutting blade of the device cuts and melts an end of the zipper profile from the supply of zipper. Since the full cutting face of the blade is heated, the width of the profile of the zipper can be cut and tack-sealed at a typical cutting speed. As a second end of the zipper is cut and melted to form a tack-seal, the zipper now includes a tack-seal at each end of the cut length. The length of zipper is then attached to the surface of the thermoplastic film used to make a reclosable bag. The tack-seals maintain the alignment of the interlocking profiles of the zipper as the zipper is attached to the film; however, the tack-seals are easily separable when subsequently used by a consumer.

### BRIEF DESCRIPTION OF THE DRAWINGS

Further objects and advantages of the invention will become apparent from the following description and claims taken in conjunction with the accompanying drawings, in which:

FIG. 1 is a perspective view of the zipper cutting device of the present invention being used to produce a first tack-seal on one end of a fastener strip or zipper;

FIG. 2 is a perspective view of the zipper cutting device of the present invention being used to produce a second tack-seal on an opposite end of the fastener strip or zipper; and

FIG. 3 is a sectional view of the zipper cutting device of the present invention with the view taken from reference line 3-3 of FIG. 1.

### DETAILED DESCRIPTION OF THE PREFERRED EMBODIMENTS

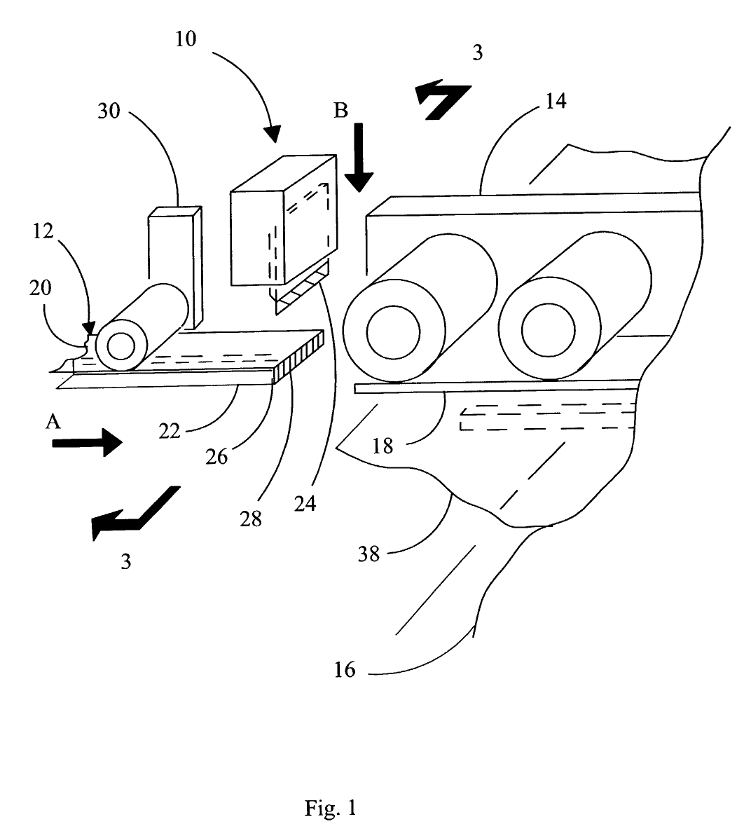

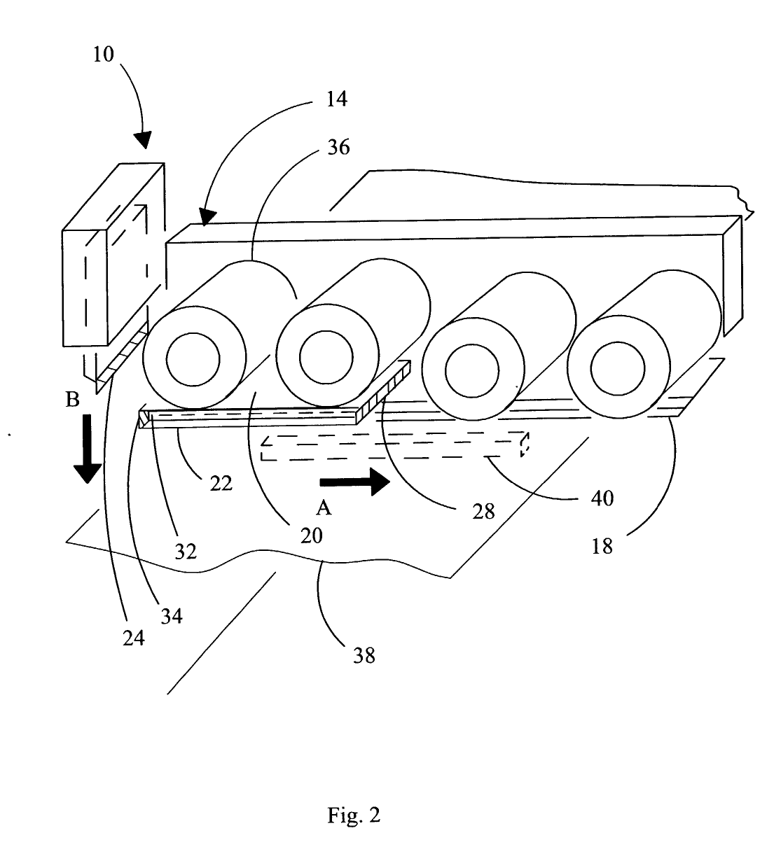

Referring now to the drawings in detail in which like numerals indicate like elements throughout the several views, the zipper cutting device 10 of the present invention is shown in FIG. 1. For the purpose of illustrating a first cut of a fastener strip or zipper 12 by the cutting device 10, a zipper applicator 14 is shown in the figure as sectionalized by a cut-line 16. A full view of the zipper applicator 14 is shown in FIG. 2.

As shown in FIG. 1, as the zipper 12 is advanced to a zipper guide 18 of the zipper applicator 14 in movement direction “A”, the zipper is stopped and cut by the zipper cutting device 10. The zipper 12 moves in direction “A” by the engagement of the two profiles 20, 22. At a typical cutting speed by movement in direction “B”, the full cutting face of heated blade 24 of the device cuts through the zipper 12. As the heated blade 24 cuts through the zipper 12 at a first section 26, the full cutting face of the blade also fuses the zipper to provide a first tack-seal 28. The zipper 12 is then advanced by a zipper driver 30 or by the zipper applicator 14 in movement direction “A”.

As shown in FIG. 2, the zipper 12 is advanced at a predetermined length and the heated blade 24 again cuts through the zipper in movement direction “B”. As the heated blade 24 cuts through the zipper 12 at a second section 32, the zipper is fused to provide a second tack-seal 34. The rollers 36 of the zipper applicator 14 further engage the zipper 12 until the zipper is positioned for attachment to the film 38 used to make a reclosable bag. The attachment of the profiles 20, 22 at their interlocking members and at the tack-seals 28, 34 permits the rollers 36 of the zipper applicator 14 to move both profiles at the same speed. The result is that the profiles 20, 22 remain aligned with each other as they are moved on the zipper guide 18 until the profiles are sealed to the film 38 by a sealing bar 40.

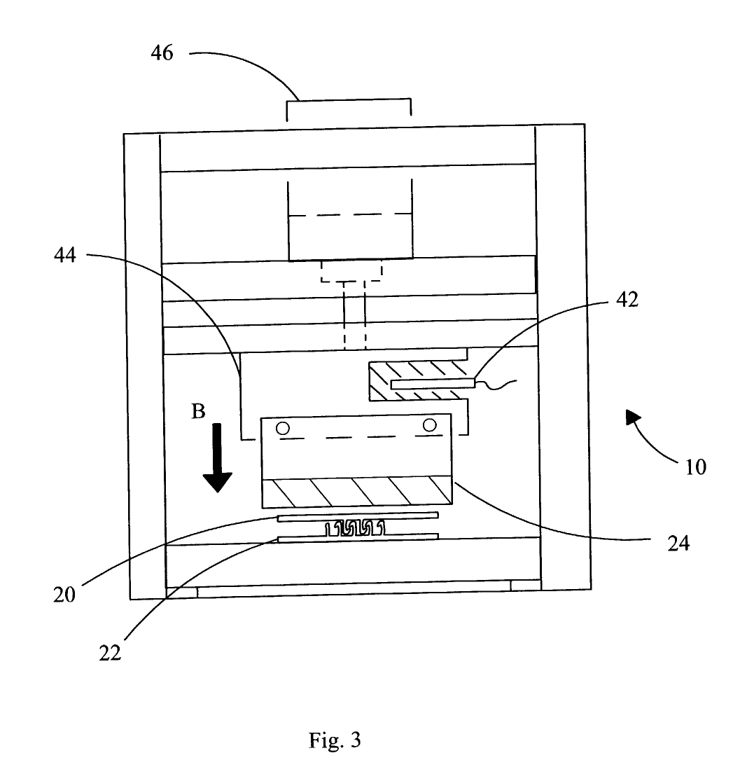

As depicted in FIG. 3, a heating element 42 heats a plunger 44 of the zipper cutting device 10. The heating element 42 is preferably an electrically connected element; however, other mediums may be used as the heating element. The plunger 44, which is attached to the heated blade 24, heats the full cutting face of the blade without interfering with the cutting motion of the blade. During operation of the zipper cutting device 10, an air reciprocating piston 46 forces the plunger 44 and the heated blade 24 in the movement direction “B”, thereby cutting and tack-sealing the zipper 12 in the manner shown in FIGS. 1 and 2. The air reciprocating piston 46 is the preferred moving medium; however, other moving mediums known to those skilled in the art may be used with the tack knife 10.

Thus, the several aforementioned objects and advantages are most effectively attained. Although preferred embodiments of the invention have been disclosed and described in detail herein, it should be understood that this invention is in no sense limited thereby and its scope is to be determined by that of the appended claims.

What is claimed is:

1. A device for cutting and producing tack-seals on a zipper from a continuous length of zipper, said device comprising:
a heating element;
a plunger connected to a moving medium, said plunger grooved to accommodate said heating element and receptive to a heating action by said heating element;
a cutting face with a first edge and a cutting edge opposite said first edge, said cutting face attached to said plunger at said first edge wherein said cutting face is receptive to a reciprocating action of said plunger and said heating action; and
a blade disposed on said cutting edge, the width of said blade providing a combined cutting and tack-sealing action to the zipper in response to said reciprocating action and said heating action such that the zipper includes tack-sealed ends when cut from the continuous length of zipper.

2. The device of claim 1 wherein said moving medium is an air-driven piston.

3. A method for the combined cutting and tack-sealing of a zipper used in making a reclosable bag, said method comprising the steps of:
providing a continuous length of zipper;
cutting the continuous length of zipper at the first end section;
tack-sealing the first end section during said cutting step of the first end section such that a first tack-seal is provided;
advancing the continuous length of zipper to a second end section;
cutting the continuous length of fastener strip at the second end section;
tack-sealing the second end section during said cutting step of the second end section so that a second of the tack-seals is provided; and
thereby creating a length of zipper including the first and second tack-seals at the end sections.

4. The method in accordance with claim 3, said method comprising the further steps supplying a continuous length of thermoplastic film used to make the reclosable bag and attaching the length of zipper with the first and second tack seals crosswise with respect to the direction of movement of the thermoplastic film.

5. An apparatus for cutting and producing tack-seals on a zipper supplied from a continuous length of zipper, said apparatus comprising:
means for cutting and fusing a first end section of the continuous length of zipper so that a first tack-seal is provided at the first end section; and
means for cutting and fusing a second end section of the continuous length of zipper so that a second tack-seal is provided at the second end section such that the zipper includes tack-sealed ends when cut from the continuous length of zipper.
